(19) United States
(12) Patent Application Publication
(10) Pub. No.: US 2026/0103164 A1
(43) Pub. Date: Apr. 16, 2026

(54) BELT ANCHOR FIXING STRUCTURE

(71) Applicant: TOYOTA JIDOSHA KABUSHIKI KAISHA, Toyota-shi (JP)

(72) Inventor: Koji SAEKI, Okazaki-shi (JP)

(73) Assignee: TOYOTA JIDOSHA KABUSHIKI KAISHA, Toyota-shi (JP)

(21) Appl. No.: 19/221,961

(22) Filed: May 29, 2025

(30) Foreign Application Priority Data
Oct. 10, 2024 (JP) 2024-177720

(51) Int. Cl. B60R 22/22; B60K 1/04; B60N 2/015; B60R 16/04; B62D 21/03; B62D 25/18

(52) U.S. Cl. CPC B60R 22/22; B60N 2/015; B60R 16/04; B62D 21/03; B62D 25/18; B60K 1/04; B60K 2001/0438

(57) ABSTRACT

A fixing structure of a belt anchor includes a rear seat mounted on a vehicle, a cross member extending in a vehicle width direction near a rear end of the rear seat, a belt anchor fixed to the cross member, and a seat belt connected to the belt anchor, wherein the belt anchor is fixed on a straight line parallel to a pulling direction of the seat belt and passing through a centroid of the cross member.

### CROSS-REFERENCE TO RELATED APPLICATION

This application claims priority to Japanese Patent Application No. 2024-177720 filed on Oct. 10, 2024. The disclosure of the above-identified application, including the specification, drawings, and claims, is incorporated by reference herein in its entirety.

### BACKGROUND

### 1. Technical Field

The present specification discloses a fixing structure for a belt anchor fixed to a cross member.

### 2. Description of Related Art

As is well known, the seat of a vehicle is provided with a seat belt device that restrains the body of an occupant in the event of a vehicle collision. In general, part of the seat belt of the seat belt device is connectable to a buckle. The buckle is often fixed to the vehicle via a belt anchor. For example, Japanese Unexamined Patent Application Publication No. 2010-173497 (JP 2010-173497 A) discloses a configuration in which a belt anchor is fastened to a lower arm that is part of a seat frame.

### SUMMARY

Due to a sudden stop or collision of the vehicle, the occupant may fall toward the front of the vehicle, and the belt may be strongly pulled. At this time, a large pulling force acts on the belt anchor as well. In the related-art structure, the large pulling force is received only by the fastening portion of the belt anchor. Therefore, the fastening portion of the belt anchor needs to have a firm configuration so as not to be damaged by the pulling force. As a result, there is a problem that the size and cost of the fixing structure for the belt anchor increase.

Therefore, the present specification discloses a belt anchor fixing structure with which the structure of a belt anchor can further be simplified.

A belt anchor fixing structure according to a first aspect of the present disclosure includes:

a seat mounted on a vehicle;

a cross member extending in a vehicle width direction near a rear end of the seat;

a belt anchor fixed to the cross member; and

a seat belt connected to the belt anchor.

The belt anchor is fixed on a straight line parallel to a pulling direction of the seat belt and passing through a centroid of the cross member.

With this configuration, the load input to the belt anchor is efficiently transmitted to the cross member. Therefore, the belt anchor is effectively prevented from being detached or damaged.

In this case, the cross member may be part of a die-cast component that is a monoblock casting of the cross member and a pair of right and left wheelhouses, and the belt anchor may be integrally cast with the cross member as part of the die-cast component.

In the case of die casting, a complex shape can be formed easily. Therefore, in the case of die casting, the cross member and the belt anchor can be integrally cast easily. By integrally casting the cross member and the belt anchor, the force acting on the belt anchor can be transmitted to the cross member more reliably.

The cross member may be part of a die-cast component that is a monoblock casting of the cross member and a pair of right and left wheelhouses, and the cross member may include a fixing portion to which the belt anchor is fixed, and a plurality of ribs extending radially from a vicinity of the fixing portion.

By providing the ribs extending radially from the vicinity of the fixing portion, the load input to the belt anchor can be distributed more effectively. By forming the cross member as part of the die-cast component, it is possible to realize a complex shape having ribs etc.

The belt anchor fixing structure may further include a battery pack disposed under a vehicle floor, and an end of the battery pack may be fastened to the cross member.

With this configuration, part of the load transmitted from the belt anchor to the cross member is further transmitted to the battery pack. Thus, the load can be distributed more efficiently.

With the technology disclosed in the present specification, the structure of the belt anchor can further be simplified.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view showing the arrangement of the main components;

FIG. 2 is a schematic view of a rear seat;

FIG. 3A is a III-III sectional view of FIG. 2;

FIG. 3B is an enlarged view of 3B portion of FIG. 3A;

FIG. 4 is a perspective view of the lower belt anchor periphery; and

FIG. 5 is a schematic plan view of the belt anchor periphery.

### DETAILED DESCRIPTION OF EMBODIMENTS

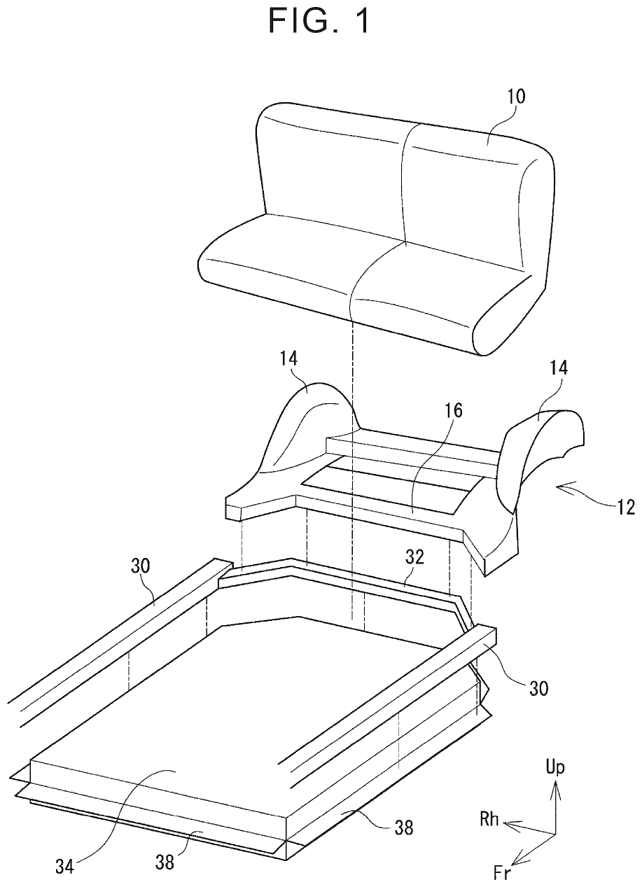

Hereinafter, a fixing structure of the belt anchor 52 will be described with reference to the drawings. FIG. 1 is an exploded perspective view showing the arrangement of the main components. In the drawings, Fr, Up, Rh indicate the front, upper, and right sides of the vehicles, respectively.

The vehicle illustrated in the present embodiment is an electrified vehicle having a traveling motor (not illustrated) as a power source. Electrified vehicle may be a hybrid battery electric vehicle or a battery electric vehicle. As shown in FIG. 1, the vehicle includes a rear seat 10, a die-cast component 12, a side member 30, and a battery pack 34. The rear seat 10 is a seat disposed at a rear portion of the vehicle. The rear seat 10 is, for example, a bench seat on which three persons can sit. A seat belt device to be described later is incorporated in the rear seat 10. The rear seat 10 is connected to a body or a frame of the vehicle via a seat frame or a seat rail (not shown).

The die-cast component 12 and the side member 30 constitute a frame of the vehicle. The side member 30 is a frame member extending in the vehicle front-rear direction at an end portion in the vehicle width direction of the vehicle cabin. The side member 30 is, for example, a hollow member having a substantially rectangular cross section. A sub-cross member 32 is connected to the rear end of the side member 30. The sub-cross member 32 extends in the vehicle width direction and connects the rear ends of the two side members 30. In the present example, as shown in FIG. 1, the sub-cross member 32 has a substantially trapezoidal shape that is convex toward the rear of the vehicle. The front ends of the two side members 30 are connected to each other by a front cross member (not shown).

The die-cast component 12 is made of a light metal such as aluminum and is manufactured by a casting technique called “gigacast” or “megacast”. “Gigacast” or “megacast” is a technique in which a large part is integrally cast using a large mold. In the die-cast component 12 of the present example, a pair of left and right wheelhouses 14 and a cross member 16 are integrally cast.

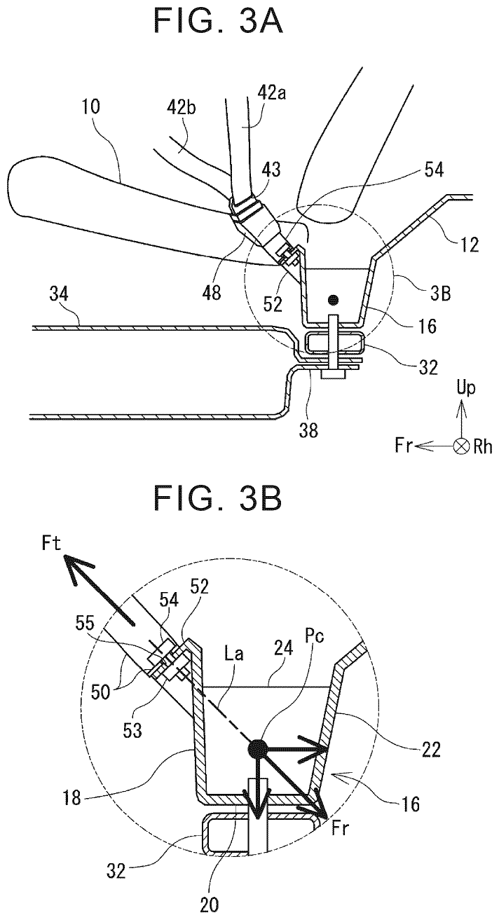

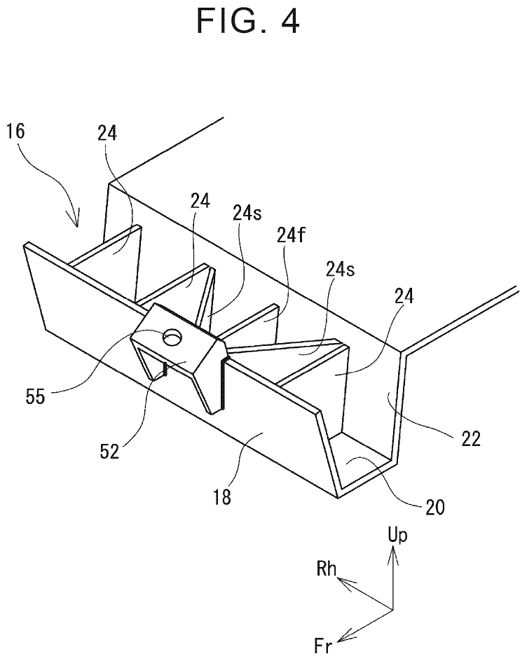

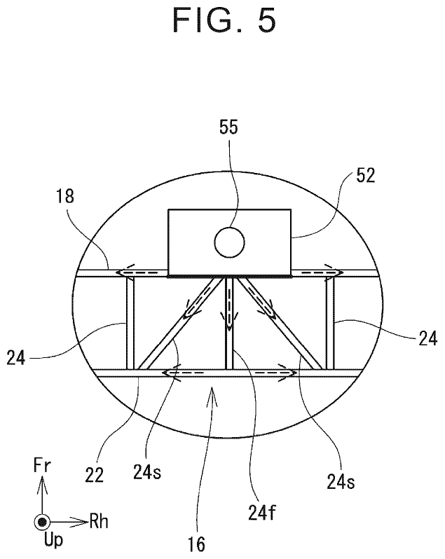

The cross member 16 is a frame member extending in the vehicle width direction. The cross member 16 is located near the rear end of the rear seat 10. Also, in FIG. 1, the cross member 16 is illustrated in a simplified manner, but the cross member 16 has a U-shaped or groove-shaped cross-section that opens upward as shown in FIG. 3A, FIG. 3B and FIG. 4. Further, as shown in FIGS. 4 and 5, a plurality of ribs 24 are formed in the groove of the cross member 16. The cross member 16 is mounted on the sub-cross member 32 and is connected to the rear end of the side member 30 and the sub-cross member 32.

A battery pack 34 is disposed under the side member 30 and the cross member 16, that is, under the floor of the vehicle cabin. The battery pack 34 is a secondary battery capable of charging and discharging electric power. The battery pack 34 has a flat shape having a smaller thickness dimension than a planar size thereof. A flange 38 extending in the horizontal direction is provided at the periphery of the battery pack 34. The outer shape of the battery pack 34 including the flange 38 is substantially the same as a substantially rectangular shape including the side member 30, the cross member 16, and the front cross member (not shown). The flange 38 of the battery pack 34 overlaps and is fastened to the side member 30, the cross member 16, and the lower side of the front cross member.

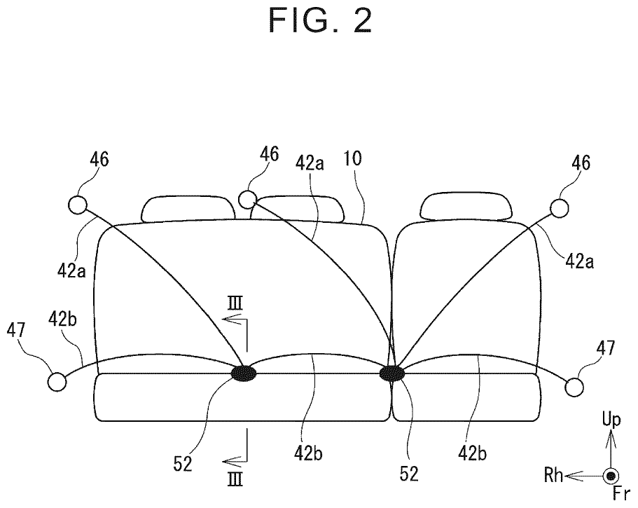

Next, a seat belt device will be described. FIG. 2 is a schematic view of the rear seat 10. Further, FIG. 3A is a III-III cross-sectional view of FIG. 2. FIG. 3B is an enlarged view of 3B portion of FIG. 3A. FIG. 4 is a perspective view of the periphery of the lower belt anchor 52, and FIG. 5 is a schematic plan view of the periphery of the belt anchor 52.

Three seat belt devices are incorporated in the rear seat 10. Each seat belt device has a seat belt 42 that restrains the body of the occupant. The seat belt 42 is passed through a belt hole of the tongue plate 43 (see FIG. 3A). The seat belt 42 is folded back by the tongue plate 43, and thus is divided into a shoulder belt 42a obliquely upward from the tongue plate 43 and a lap belt 42b laterally from the tongue plate 43.

The upper end of the shoulder belt 42a (that is, the end opposite to the tongue plate 43) is fixed to the vehicle body via the upper belt anchor 46. Further, a winding device (not shown) for controlling winding and pulling out of the seat belt 42 is connected to the shoulder belt 42a. The end of the lap belt 42b facing away from the tongue plate 43 is secured to the body or cross member 16 via an outer belt anchor 47 or a lower belt anchor 52.

A buckle 48 (FIG. 3A) to which the tongue plate 43 is releasably connected is provided in the vicinity of the rear end of the seat surface of the rear seat 10. The buckle 48 is fixed to the cross member 16 via a connecting belt 50 and a lower belt anchor 52, which will be described later. In the present example, in order to reduce the load acting on the lower belt anchor 52, the attachment position and the posture of the lower belt anchor 52 are adjusted. Hereinafter, this will be described in detail. Hereinafter, the lower belt anchor 52 is referred to as a “belt anchor 52”.

The connecting belt 50 is fastened to the belt anchor 52 by fastening bolts 54. Further, the belt anchor 52 is fixed to the cross member 16 as shown in FIG. 3A, FIG. 3B, and FIG. 4. More specifically, the cross member 16 has a substantially groove shape having a front wall 18, a bottom wall 20, and a rear wall 22. The belt anchor 52 is secured to the front wall 18 of the cross member 16. Such a belt anchor 52 may be integrally molded with the cross member 16. That is, in the present example, the cross member 16 is manufactured by die casting. In the case of die casting, complex shapes can also be easily produced. Therefore, in the case of die casting molding, the belt anchor 52 shown in FIG. 4 can be integrally cast with the cross member 16. Alternatively, the belt anchor 52 may be manufactured as a separate component from the cross member 16 and attached to the cross member 16 by fastening or welding.

In any case, a fastening hole 55 through which the fastening bolt 54 is inserted is formed in the center of the belt anchor 52. A nut 53 threadedly engaged with the fastening bolt 54 is welded to the rear side of the fastening hole 55. The fastening bolt 54 is screwed to the nut 53 in a state where the connecting belt 50 is sandwiched between the head portion and the belt anchor 52. As a result, the connecting belt 50 and thus the seat belt 42 are fixed to the cross member 16.

Here, the belt anchor 52 is disposed on a straight line La that is parallel to the pulling-direction At of the seat belt 42 and passes through the centroid Pc of the cross member 16, as shown in FIG. 3A and FIG. 3B. The pulling direction At is a direction in which the buckle 48 is pulled when the occupant falls forward due to a sudden stop or collision of the vehicle. Such a pulling direction At is, for example, the direction specified in “6.3.2” of “Attachment-position and strength of seat belt of JIS D 4609:1993 passenger car”. Such tensile direction At is or is the direction specified in “6.3.2” of Agreement Regulation No. 14, “Uniform Regulations for the Authorization of Vehicles for Seat Belt Attachment Devices, ISOFIX Mechanism Attachment Devices and ISOFIX Top Tether Attachment Devices” of the “Type Approval and Mutual Recognition Agreement for Vehicles, etc.” (ECE). That is, the direction of the pulling force used in the test “shall apply the pulling force in a direction corresponding to the seating position in a plane parallel to the central longitudinal section of the vehicle and angled 10°±5° upward from the horizontal plane” defined in the standard is the pulling direction At.

By disposing the belt anchor 52 on such a straight line La, the tensile force Ft transmitted to the belt anchor 52 can be efficiently distributed to the cross member 16. That is, the tensile force Ft acting on the belt anchor 52 is transmitted to the centroid Pc of the cross member 16. In the centroid Pc, a reaction force Fr is generated with respect to the tensile force Ft. Further, the reaction force Fr is distributed horizontally and vertically as indicated by the thick arrow in FIG. 3B. As a result, force concentration is suppressed and deformation or breakage of the belt anchor 52 and the cross member 16 is effectively prevented. This improves the load-bearing performance of the belt anchor 52.

Heretofore, in order to improve the proof stress performance of the belt anchor 52, the strength of the belt anchor 52 alone has been improved. In the related art, the belt anchor 52 has become larger or more expensive. On the other hand, in the present embodiment, since the belt anchor 52 is disposed on the above-described straight line La, the tensile force Ft acting on the belt anchor 52 can be efficiently distributed to the cross member 16. Thus, the bearing capacity performance of the belt anchor 52 can be improved without increasing the cost or increasing the size of the belt anchor 52 itself.

Further, in the present embodiment, in order to more efficiently distribute the tensile force Ft, the ribs 24 are provided in the grooves of the cross member 16 as shown in FIGS. 4 and 5. The ribs 24 are arranged substantially radially from a fixing portion of the belt anchor 52 to the cross member 16 in a plan view. More specifically, the cross member 16 has a first rib 24f and a pair of second rib 24s. The first rib 24f is a rib 24 connecting the front wall 18 and the rear wall 22, and is a rib extending straight rearward in a plan view. Two second rib 24s are arranged on both left and right sides of the first rib 24f. The second rib 24s is also a rib 24 connecting the front wall 18 and the rear wall 22. However, in plan view, the second rib 24s advances obliquely rearward so as to be separated from the first rib 24f as it advances rearward.

The front ends of the two second rib 24s are located near the front ends of the first rib 24f. The front ends of the three ribs 24f, 24s are located near the fastening holes 55 of the belt anchor 52. The front wall 18, the first rib 24f, and the second rib 24s thereby form a wall extending radially from the fastening hole 55.

With such a configuration, the force transmitted from the belt anchor 52 to the front wall 18 is further transmitted to the front wall 18 and the ribs 24f, 24s, as indicated by the dashed arrows in FIG. 5. As a result, the tensile force Ft is more reliably dispersed, and thus the concentration of the force is suppressed. As a result, deformation and breakage of the belt anchor 52 and the cross member 16 are effectively prevented. The rib 24 for distributing the force acting on the belt anchor 52 may extend radially from the vicinity of the fixing portion of the belt anchor 52 to the cross member 16. Here, the “fixing portion” is a portion where the belt anchor 52 and the cross member 16 are connected to each other, and is a portion where a force is transmitted from the belt anchor 52 to the cross member 16. In the example of FIG. 4 and FIG. 5, the thick line portion is a “fixing portion”.

As described above, in the present example, the battery pack 34 is fastened to the lower side of the cross member 16. In this case, a part of the force transmitted to the cross member 16 is further transmitted to the battery pack 34 via the fastening portion between the cross member 16 and the battery pack 34. The battery pack 34 is a large and heavy component. When the battery pack 34 receives a part of the force, deformation or breakage of the belt anchor 52 and the cross member 16 is more effectively prevented.

As is apparent from the above description, in the present example, the force acting on the belt anchor 52 is efficiently distributed to the cross member 16 and the battery pack 34. As a result, the buckle 48 and thus the seat belt 42 can be properly held without excessively increasing the strength of the belt anchor 52 itself. As a result, the structure of the belt anchor 52 can be simplified compared to the prior art.

Note that any of the configurations described above is an example, and other configurations may be changed as long as the configuration described in claim 1 is provided. For example, in the previous description, the cross member 16 is part of a die-cast component 12 that includes a pair of wheelhouses 14. However, the cross member 16 may be a separate component separate from the wheelhouse 14. For example, the cross member 16 may be formed by welding a plurality of sheet metal members. Further, in the above description, the battery pack 34 is fastened to the lower side of the cross member 16, but the battery pack 34 may be fastened to another place.

What is claimed is:

1. A belt anchor fixing structure comprising:
a seat mounted on a vehicle;
a cross member extending in a vehicle width direction near a rear end of the seat;
a belt anchor fixed to the cross member; and
a seat belt connected to the belt anchor, wherein
the belt anchor is fixed on a straight line parallel to a pulling direction of the seat belt and passing through a centroid of the cross member.

2. The belt anchor fixing structure according to claim 1, wherein:
the cross member is part of a die-cast component that is a monoblock casting of the cross member and a pair of right and left wheelhouses; and
the belt anchor is integrally cast with the cross member as part of the die-cast component.

3. The belt anchor fixing structure according to claim 1, wherein:
the cross member is part of a die-cast component that is a monoblock casting of the cross member and a pair of right and left wheelhouses; and
the cross member includes:
a fixing portion to which the belt anchor is fixed; and
a plurality of ribs extending radially from a vicinity of the fixing portion.

4. The belt anchor fixing structure according to claim 1, further comprising a battery pack disposed under a vehicle floor, wherein
an end of the battery pack is fastened to the cross member.

5. A belt anchor fixing structure comprising:
a seat mounted on a vehicle;
a cross member extending in a vehicle width direction near a rear end of the seat;
a belt anchor fixed to the cross member; and
a seat belt connected to the belt anchor, wherein
the cross member includes:
a fixing portion to which the belt anchor is fixed; and
a plurality of ribs extending radially from a vicinity of the fixing portion.
